(19) United States
(12) Patent Application Publication
(10) Pub. No.: US 2019/0347635 A1
(43) Pub. Date: Nov. 14, 2019

(54) CONFIGURING A PHYSICAL ENVIRONMENT BASED ON ELECTRONICALLY DETECTED INTERACTIONS

(71) Applicant: Adobe Inc., San Jose, CA (US)

(72) Inventors: Zacheusz Siedlecki, Pyskowice (PL); Sandeep Aggarwal, Delhi (IN); Abhishek Kumar Singh, Uttar Pradesh (IN); Deep Kamal Singh, New Delhi (IN)

(21) Appl. No.: 15/976,212

(22) Filed: May 10, 2018

(51) Int. Cl. G06Q 20/20; G06K 7/10; G06K 9/00; G06F 17/30; H04W 4/35

(52) U.S. Cl. CPC G06Q 20/208; G06K 7/10009; H04W 4/35; G06F 17/30964; G06K 9/00288

(57) ABSTRACT

Disclosed systems and methods include configuring behavior of a machine in a physical environment based on detected interactions with the physical environment. In some cases, an electronic identification device identifies a presence of an object in the physical environment. An attribute corresponding to the identified object is determined, the attribute identifying a characteristic of a user or group or users of the physical environment. The attribute is matched to a parameter indicating an environment device and a configuration of the environment device. In some cases, the configuration is based on historical information about interactions in the physical environment, and the user characteristic. Behavior of the environment device is modified based on the configuration.

### TECHNICAL FIELD

This disclosure relates generally to control systems in which computing devices that monitor user behavior automate the operations of machines in a physical environment. More specifically, but not by way of limitation, this disclosure relates to configuring the operations of various devices in a user's physical environment based on electronically detecting an interaction with an object or a person.

### BACKGROUND

Internet devices can interact with content providers to create customized content. For example, a web server logs interactions with a website and customizes an online experience provided by the website to a particular user. The web server customizes the online experience by, for example, automatically changing the content displayed to a user online in response to the user's interactions. In some cases, the web server monitors additional interactions from the user to determine the user's response to the customization.

But while existing solutions can alter an online environment based on user interactions, these solutions cannot alter the user's physical environment in the real world based on the interactions. For instance, even if a user interacts with an electronic service related to a physical environment, the configuration of the physical environment (e.g., lighting levels, operations of particular machines, etc.) remains constant. Thus, physical environments cannot be automatically modified to a particular user in the way that digital environments can. Additionally, the user's response to the modification cannot be monitored.

Accordingly, solutions are needed to enable the modification of the physical experience of a user based on interactions of the user with the physical environment. Solutions are also needed to customize the modification of the physical environment based on a user's response to the modification.

### SUMMARY

Embodiments are disclosed herein for configuring the operations of various devices in a user's physical environment based on electronically detecting an interaction with an object or a person. For example, some embodiments include receiving a notification from an electronic identification device. The notification indicates an object present in the physical environment and an identifier of the object. An attribute that corresponds to the identifier is determined, such that the attribute identifies a characteristic of a user or a group of users of the physical environment. In some cases, the attribute is based on historical information about interactions with additional objects.

The attribute is matched, for example, to a parameter in an environment data structure. The parameter indicates an environment device, such as a device capable of modifying the physical environment. In addition, the parameter indicates a configuration of the environment device. In some cases, the configuration is based on one or more of the historical information or the characteristic. The behavior of the environment device is changed, such as by implementing the configuration on the environment device.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

Features, embodiments, and advantages of the present disclosure are better understood when the following Detailed Description is read with reference to the accompanying drawings.

FIG. 1 depicts an example of an environment modification system for configuring the operations of various devices in a user's physical environment based on electronically detecting an interaction with an object or a person, according to certain embodiments of the present disclosure.

FIG. 2 depicts an example use of the environment modification system of FIG. 1, according to certain embodiments of the present disclosure.

FIG. 3 depicts an example of a method for configuring the operation of devices in a physical environment based on electronically detected interactions with the physical environment, according to certain embodiments of the present disclosure.

FIG. 4 depicts an example of a data flow for the environment modification system of FIG. 1, according to certain embodiments of the present disclosure.

FIG. 5 depicts an example of a computing system for implementing certain embodiments of the present disclosure.

### DETAILED DESCRIPTION

Embodiments described herein use computing devices to provide customized physical environments by configuring the operations of various devices in the environment based on electronically detecting interactions. For instance, based on a user's interactions with an identified object, a computing device configures one or more environment devices (e.g., lights, temperature controllers, window shades, etc.) into modes that are personalized for a given user (e.g., setting lights to illumination levels, setting thermostats to temperatures desirable to the user, etc.). In turn, the computing device detects and measures the user's reaction to the changes in the environment. In some cases, the computing device may modify the configuration of the physical environment based on the detected reaction of the user.

The following non-limiting example is used to introduce certain embodiments. An environment application running on a computing device receives sensor data from an electronic identification device, such as a radio frequency identification device (RFID) reader or other sensor, indicating the presence of an object. The sensor data is generated by, for example, a person picking up an object monitored by the electronic identification device, such as an item of clothing from a rack of clothing items to which the electronic identification device is attached. The sensor data includes an identifier that corresponds to the object from the identification device. For instance, the identifier uniquely identifies a particular item of clothing. The environment application also determines an attribute that corresponds to the identifier and provides characteristics of users that may interact with the object. For instance, the environment application accesses an attribute data structure that stores target demographic information about the item of clothing such as the target audience (e.g., male, female), characteristics of the item (e.g., sports, technology), etc. The correspondence between the attribute and the identifier indicates that a particular type of user has interacted with the object (e.g., a male who prefers items with sports characteristics).

Continuing with this example, the environment application determines, from an environment data structure obtained from an environment server, how to configure a physical environment in which the electronic identification device is positioned based on the determined attribute. For instance, the environment data structure includes one or more configuration profiles or parameters identifying environment devices (e.g., lights, window controls, music, fragrance-emitters, etc.) positioned within the environment. In some cases, the configuration profile or parameter are based on information describing previous interactions in the physical environment. A given parameter could indicate that the environment application, when configured for the determined attribute, should include a particular color or set of colors of lighting and a fragrance that matches the item. Based on this parameter, the environment application configures the physical environment by activating the colorful light and causing a fragrance device to release the matching fragrance. In this manner, a user's physical environment is altered based on the user's interaction with the item.

In some embodiments, the environment application configures the physical environment based on the previous interactions with additional objects that are similar to the identified object. Additionally or alternatively, the environment application determines that the person interacting with the identified object shares one or more characteristics with other people who previously interacted with the similar objects. In some cases, the environment application determines a configuration based on the shared characteristics. For instance, the environment application determines historical parameters or other configuration information describing how the environment devices were configured during the previous interactions, and modifies the user's physical environment based on the historical information.

The environment application also detects and measures a user's subsequent reaction to the changes in the environment. For example, the environment application could receive additional sensor data indicating that a particular clothing item was removed from a shelf after the physical environment was configured. The environment application correlates this additional interaction with the object (e.g., the removal of the clothing item) with configuration data for one or more environment devices. The correlation could indicate that that certain environmental changes are more effective in influencing a user to perform a certain action (e.g., select the clothing item), and can incorporate information from this analysis into one or more of the attribute data structure or the environment data structure for subsequent changes to the physical environment.

This disclosure provides improvements to environment modification systems that operate in controlled environments. More specifically, embodiments described herein modify various environment devices in a physical environment of a person based on electronic detection of interactions with an object or a person. An environment application correlates certain types of sensor data such as identification or movement with characteristics of a person (or a group of people with similar characteristics) within the environment in order to determine a configuration of one or more machines, such as environment devices that alter an aspect of the physical environment.

For example, a sensor such as an RFID reader mounted in a controlled environment receives raw data such as a pulse from an object that is tagged with an RFID tag. The pulse includes an radio-frequency identifier that identifies the object. In turn, an environment application receives the identity from the RFID reader. The identification code uniquely identifies a particular object, for example, in a database. A second sensor such as a motion sensor detects movement of a person or an object in the environment. In response, the environment application adjusts the operation of machinery such as lights, moveable walls, or audio devices, in controlled environment. For example, the environment application dims a set of lights and closes a curtain, thereby changing the physical environment.

In some embodiments, the operation of the machinery is adjusted based on historical information identifying previous interactions with objects. For example, the environment application correlates an object interaction with previous interactions with similar objects (e.g., objects having similar or identical characteristics). The environment application also correlates previous environmental configurations with the previous interactions. In some cases, the previous interactions are associated with a group of users having characteristics or profiles similar to a current user of the physical environment. Based on the correlation of the previous environmental configurations and the previous interactions, the environment application adjusts the operation of the machinery to create an environment associated with a particular type of previous interaction (e.g., purchasing the clothing item).

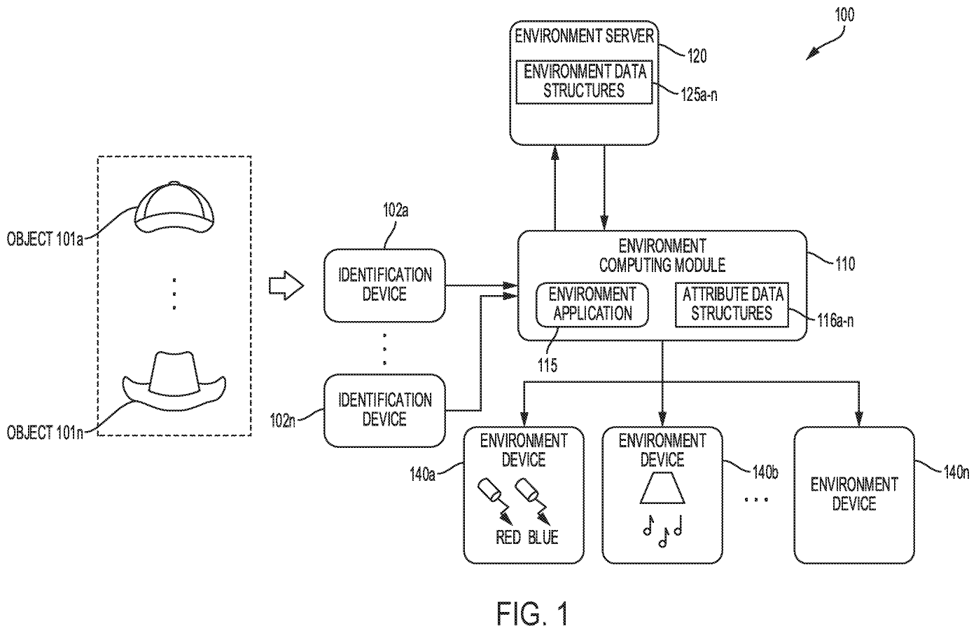

FIG. 1 depicts an example of an environment modification system for configuring the operations of various devices in a user's physical environment based on electronically detecting an interaction with an object or a person, according to certain embodiments of the present disclosure. In this example, environment modification system 100 includes one or more of objects 101a-n, an environment computing module 110, identification devices 102a-n, an environment server 120, and environment devices 140a-n. Environment computing module 110 executes one or more software applications such as environment application 115. In an example, environment application 115 receives an identification of one or more objects 101a-n from one or more identification devices 102a-n. In response, according to various attributes and parameters explained further herein, environment application 115 activates one or more environment devices 140a-n, and measures a user's reaction to the changes in the environment. In this manner, environment application 115 can learn an association between objects 101a-n and actions taken by users interacting in the physical environment. In some cases, historical information indicates the learned association, the user interactions, or both. As explained herein, environment application 115 can perform such operations alone or in conjunction with an additional device, such as environment server 120.

Identification device 102a-n detects a presence of and identifies one or more objects 101a-n. Objects 101a-n can be identified by different means. For example, objects 101a-n can incorporate tags such as radio frequency identification device (RFID) tags that are read by one of the identification devices 102a-n. Other sensors can be used, such as mechanical sensors, cameras in conjunction with image recognition (e.g., identify an object, detect a barcode, detect a QR-code), or any other type of sensor. Identification device 102a-n can use any sensors that detect movement, light, sound, radio frequencies, or other characteristics. For example, each identification device 102a-n can use one or more sensors such as motion sensors, fingerprint sensors, or infrared sensors that detect the movement of objects 101a-n. An object 101a-n can be identified by a unique object identifier (ID).

In some cases, one or more of the identification devices 102a-n can determine a physical presence or an identity of a person, animal, or other being. For example, using an image sensor in conjunction with facial recognition, identification device 102a-n determine that a particular person is present. Identification device 102a-n can also use short-range communication technologies such as near-field communications (NFC), BlueTooth®, data-over-sound (e.g., Chirp™), or beacons received from a device, such as an access card or a mobile phone.

Environment devices 140a-n include devices that alter the physical environment of a user, such as lights, remote control doors, sound-emitting devices, and the like. Environment application 115 activates environment devices 140a-n. Activation refers to turning an environment device on, off, or adjusting a parameter of the environment device such as loudness, intensity, or brightness, or some other output function or parameter. For example, environment application 115 can activate a lighting device by turning the device on, adjusting the color or intensity of the light, or flashing the light (e.g., on or off).

Environment devices 140a-n can include lighting devices, such as environment device 140a. Lighting devices include (without limitation) LED, fluorescent, incandescent, and other lights. In an example, the presence of an object 101a-n causes environment computing module 110 to activate an environment device 140a-n that is a lighting unit above a display of similar objects. Environment devices 140a-n can include visual devices that emit images or videos. For example, environment devices 140a-n can include projectors, screens, monitors, color-changing walls, and the like.

Environment devices 140a-n can include audio devices that emit sounds or music, such as environment device 140b. For example, an environment device 140b can be a loudspeaker, buzzer, piezo electric device, or any device that emits sound. Environment computing module 110 can activate an environment device 140a-n to play a particular music soundtrack or to adjust a volume in response to a particular object 101a-n being identified.

Environment devices 140a-n can include devices capable of altering the physical space around an object or a person. For example, environment devices 140a-n can move a shelf, move mobile walls, raise or lower the height of a ceiling, open or close doors or windows, move furniture, or any other suitable adjustment of the environment. Environment devices 140a-n can be devices that dispense food or water, or control air temperature or air flow. For example, identification device 102a-n can determine a presence of an animal and cause a feeding device to activate so that the animal may eat. Environment devices 140a-n can emit scents such as fragrances. For example, if object 101a-n is a bottle of fragrance, then environment computing module 110 can cause an environment device 140a-n to release some of the fragrance, thereby facilitating the real-world experience of the fragrance.

Activation of environment devices 140a-n can be performed based on attribute data stored in attribute data structures 116a-n. Each attribute data structure 116a-n can correspond to a respective object 101a-n and include data objects such as intended age, gender, or activity. In some cases, an attribute data structure 116a-n identifies a characteristic of a group of users, such as users that have previously interacted with the corresponding object. For example, if environment application 115 receives an indication that a user is interacting with object 101a, such as a baseball cap, then environment application 115 can retrieve attribute data structure 116a. The attribute data structure 116a includes, for example, data objects that indicate that the baseball cap is likely to be targeted to a male of age 15-40 who is interested in sports. Environment application 115 can then take action accordingly, such as activating environment devices 140a-n to display images of baseball players or teams.

In some cases, the attribute data structure 116a is based on information received from one or more server systems, such as environment server 120. For example, environment computing module 110 communicates with environment server 120 to access information about objects 101a-n or users. In some cases, the environment server 120 is an external server system, such as a remote server (including physical, virtual, or distributed server systems) that is accessible via one or more networks. Additionally or alternatively, the environment server 120 is included in a computing system that also includes the environment computing module 110, such as a server module on a computing device that has the environment computing module 110.

In some cases, the environment server 120 provides to the environment computing module 110 information about an object with which the user has interacted, such as object 101a. For example, environment server 120 receives from environment computing module 110 an identification of the object 101a. Based on the identification, the environment server 120 provides one or more attributes about the object 101a. The attributes include, for example, demographic data indicating an audience of the object (e.g., sports-interested males between 15-40 years of age), a parameter indicating an action associated with the object 101a (e.g., display images of baseball players), or any other type of suitable data. In some cases, environment server 120 determines the attributes based on historical information about previous interactions with similar objects. For example, if environment server 120 determines, based on previous interactions, that objects similar to 101a are purchased more frequently if a red light is displayed near the object, the environment server 120 generates an attribute includes a parameter to turn on one of the environment devices 140a-n that includes a red light. Additionally or alternatively, environment server 120 determines the attributes based on historical information about previous interactions of the user who picked up object 101a, or previous interactions a group of users with characteristics similar to the current user. For example, if environment server 120 determines, based on previous interactions, that the user purchases objects more frequently if jazz music is played near the user, the environment server 120 generates an attribute including a parameter to select jazz music for another one of the environment devices 140a-n that includes a music speaker.

In some cases, environment computing module 110 can query environment server 120 to determine a parameter. The environment computing module 110 receives from environment server 120 information about a parameter, for example, in response to determining attributes from attribute data structures 116a-n or from identifying an individual who selected a particular object 101a-n. Additionally or alternatively, environment computing module 110 can query environment server 120 to determine data about the particular object 101a-n. For example, environment server 120 determines information describing the object, such as from a database included in an additional computing system.

Environment application 115 can also query environment server 120 to access additional data objects such as environment data structures 125a-n. In some cases, the environment data structures 125a-n include data that facilitates a more personalized experience for the user. Each environment data structure 125a-n can include information about a particular object 101a-n, or previous interactions with the object (or with similar objects). Additionally or alternatively, each environment data structure 125a-n can include information about a particular individual, the individual's interactions with an online service such as a website or mobile application, or how environment application 115 should activate one or more environment devices 140a-n in response to detecting the individual or the selection of the object 101a-n. In some cases, environment server 120 includes (or accesses) one or more stored configuration profiles of the environment devices 140a-n. A stored configuration profile includes, for example, data indicating a target audience (e.g., males between 15-40 years of age), or a parameter associated with one or more of the environment devices 140a-n. In some cases, a configuration profile is based on one or more of historical information (e.g., about previous interactions with objects), an identified characteristic of the user (or group of users), or any other suitable information. In response to receiving information indicating an interaction with an object matching the target audience of the configuration profile (e.g., baseball cap 101a), the environment server 120 provides the parameter to the environment computing module 110.

Environment data structures 125a-n can contain also contain profiles of particular identified users, such as user profiles including user preferences for certain products and services. A user profile can include demographic characteristics, such as age, gender, height, interests, income, hobbies, or any other suitable demographic characteristic. A user profile can also include historical information, such as previous purchases of a particular item (e.g., conversions).

Continuing the example above, environment application 115 receives an additional identification from identification device 102b, which is configured to identify a user by a mobile phone beacon. For example, based on data received from a mobile phone carried by the user, environment application 115 determines that the user who picked up the baseball cap object 101a has a certain identity, and in turn queries environment server 120 to determine whether the individual has a user profile. In response, environment application 115 receives environment data structure 125a from environment server 120. Environment data structure 125a includes a data object that indicates the user's favorite baseball team. In response, environment application 115 causes one of the environment devices 140a-n to display video of the user's favorite team.

In some cases, environment application 115 logs and analyzes data such as objects 101a-n selected by users, the environment devices 140a-n activated in response to a detected object or user, and the actions, if any, that a particular user took in response to the activate environment devices 140a-n. In this manner, environment application 115 learns successful sequences of triggering events, e.g., one or more particular modifications to the physical environment based on activation of environment devices 140a-n, and subsequent actions such as whether a user purchased a particular item.

Continuing the above example, environment application 115 detects that the user has purchased object 101a, the baseball cap. Detection can occur via identification device 102a-n, for example, detecting that an RFID tag in object 101a is present at a checkout counter. Detection can also occur from a payment system that is integrated into environment computing module 110. Environment computing module 110 transmits purchase data such as the quantity, price, and other information back to environment server 120, where a history is stored in a data structure or user profile such as environment data structure 125a. Upon receiving an indication that the particular user has returned to the store or environment, environment application 115 retrieves the history from environment data structure 125a and performs an additional modification of the environment devices 140a-n based on the retrieved historical data. For example, the environment server 120 modifies the stored configuration profile, such as a modification based on historical data indicating a previous interactions by the user, and provides the modified configuration profile to the environment computing module 110.

Accessing an external server such as environment server 120 also facilitates the integration of different systems, such as systems that log online user interaction data with websites. For example, online user interaction data can be gathered from user device interactions with an online service such as a website or mobile application. Such online user interaction data can subsequently be used to gather demographic information, data about past purchases, or data about the particular user's interests in order to better adapt modifications to a physical environment in the event a that a particular user interacts with an object 101a-n in the physical environment. In an example, environment application 115 determines from a query to environment server 120 that a particular user has performed online searches relating to a particular topic, e.g., searches for jeans. Based on the online interactions, environment application 115 can modify a physical experience for the user by causing one of the environment devices 140a-n to illuminate an area of the store where jeans are located.

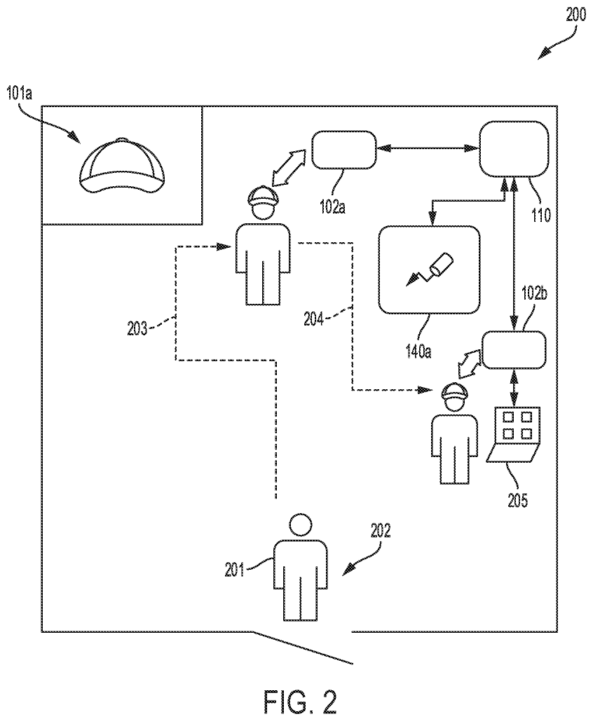

FIG. 2 depicts an example use of the environment modification system of FIG. 1, according to certain embodiments of the present disclosure FIG. 2 depicts environment 200, which includes a user 201, an entrance 202, path 203, path 204, checkout register 205, object 101a, identification devices 102a-b, environment device 140a, and environment computing module 110.

Environment 200 can be a physical environment, such as a physical retail store, demonstration area, trial room, hotel room, airline lounge, or some other area in which a user such as user 201 can interact with an object such as object 101a. Identification devices 102a-b can be located at different locations within environment 200. As a non-limiting example, FIG. 2 depicts identification device 102a located near object 101a, and identification device 102b located next to checkout register 205.

In an example, user 201 enters environment 200 via an entrance 202. User 201 walks along path 203, past various products and items, reaching object 101a. Object 101a can be any object but is shown for illustrative purposes as a baseball cap. User 201 decides to evaluate object 101a by placing it on his or her head. Identification device 102a, such as an RFID reader, determines that object 101a is present by receiving a radio frequency identification from an RFID tag on object 101a, determines an identify of object 101a, e.g., that object 101a is a particular baseball cap. Identification device 102a provides a notification to environment computing module 110.

In response to the notification, environment computing module 110 determines that attribute data structure 116a corresponds to object 101a. Environment computing module 110 accesses attribute data structure 116a-n and determines attribute that object 101a is associated with attributes “male” and “sports.”

Based on the determined attributes, environment computing module 110 requests an environment data structures from environment server 120. Environment computing module 110 receives environment data structure 125a from environment server 120. Based on a parameter indicated by environment data structure 125a, environment computing module 110 activates environment device 140a. For example, environment computing module 110 provides a parameter value (e.g., “on,” “intensity 70%”) to the environment device 140a. Responsive to receiving the parameter value, environment device 140a modifies the environment 200, such as by adjusting an output level or performing an action.

Environment computing module 110 can continue to monitor object 101a as user 201 moves object 101a down path 204. For example, environment computing module 110 can detect that user 201 has purchased object 101a. Such detection can occur via identification device 102b, via checkout register 205, or both. Checkout register 205 is depicted as connected to identification device 102b for illustrative purposes, but checkout register 205 can connect directly to environment computing module 110, or to a network device that in turn, connects to environment computing module 110.

By using one or more identification devices such as identification devices 101a-b, optionally in conjunction with checkout register 205, environment computing module 110 can detect a user's interactions with objects such as object 101a, and follow the user or the object 101 along a path such as path 203 or 204. In some cases, environment computing module 110 determines whether the user purchases object 101a. This information can be stored in a user profile or other data structure in an external device such as environment server 120. In this manner, past interactions by users with objects, such as objects 101a-n, can be stored and analyzed such that environment computing module 110 may take a modified set of actions such as further modifying the user's physical environment in subsequent interactions.

While FIG. 2 depicts one example, other implementations of an environment modification system are possible. In a further example, an environment computing module or environment devices can be incorporated into a health and wellness environment, such as a workout room. For example, the identification device can detect a presence of a particular user based on the user's access card or mobile device. Responsive to detecting that the user has entered the workout room, the environment application can turn on environment devices such as music, fans, or projection screens. Based on sensor data (e.g., biometric data received from a wearable fitness monitor) or historical information (e.g., exercise performance of similar users), the environment application learns that the user achieves a wellness goal, such as completing a physical therapy routine or exercising at a certain intensity, while environment devices are configured to provide a particular environment. In some cases, the configuration may be contrary to the user's preferences. For example, if the environment application learns that a group of users is more likely to achieve a wellness goal if fans are off, the environment application could configure a fan environment device to power off. In some embodiments, a current user provides an override, such as by powering the fan back on.

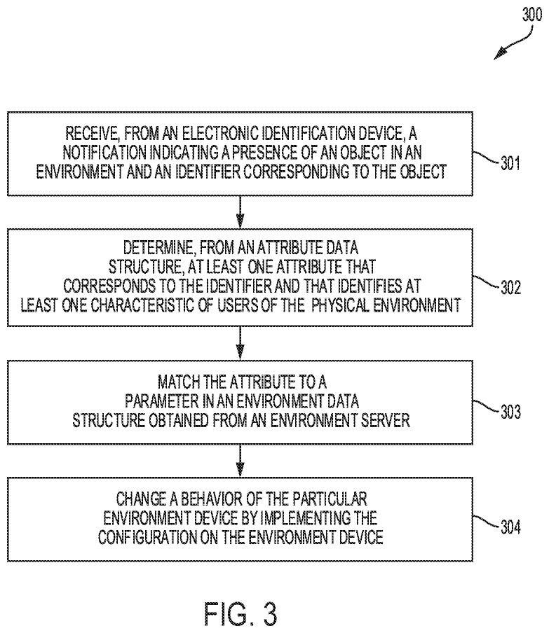

FIG. 3 depicts an example of a method for configuring the operations devices in a physical environment based on electronically detected interactions with the physical environment, according to certain embodiments of the present disclosure.

At block 301, process 300 involves receiving, from an electronic identification device, a notification indicating a presence of an object in the environment and an identifier corresponding to the object. For example, an RFID reader detects that a particular object has been moved by receiving a pulse containing an identifier corresponding to the object (such as an identifier indicated by an RFID tag). The environment application 115 receives the identifier from the RFID reader.

At block 302, process 300 involves determining, from an attribute data structure, at least one attribute that corresponds to the identifier and that identifies at least one characteristic of users of the physical environment. The environment application 115 determines that a particular attribute data structure corresponds to the particular object. Environment application 115 determines one or more attributes from the attribute data structure that are applicable to the object. For example, if the object is a bottle of perfume, then the attribute data structure may include a targeted demographic attribute of “female.”

At block 303, process 300 involves matching the attribute to a parameter in an environment data structure obtained from an environment server. The parameter indicates (i) a particular environment device, and (ii) a configuration of the particular environment device. Environment application 115 queries environment server 120 to determine an applicable environment data structure. Environment application 115 receives a particular environment data structure from environment server 120. The environment data structure includes parameters that indicate how one or more environment devices 140a-n should be adjusted in response to the particular object.

At block 304, process 300 involves changing a behavior of the particular environment device by implementing the configuration on the environment device. For example, environment application 115 activates multiple environment devices, such as a first environment device including a set of lights and a second environment device including a video projector. Activating the first environment device illuminates a counter on which additional fragrances are located. Activating the second environment device results in a projection (e.g., onto a wall) of images that correspond to the particular object.

In some cases, the environment application 115 provides activation data to an environment device. For example, the environment application 115 determines a configuration of the environment device based on an environment data structure, such as a configuration including one or more of a state (e.g., on or off), an output level (e.g., 50% output, 100% output), an output type (e.g., a selected color, a selected song), or any other suitable configuration of the environment device. Based on the determined configuration, the environment application 115 generates activation data and provides the activation data to the environment device. The activation data includes, for example, instructions indicating the configuration. Responsive to receiving the activation data, the environment device modifies a behavior, such as by implementing the instructions. For example, the environment device modifies its output level based on one or more of the received instructions.

In an embodiment, environment application 115 receives an additional identification from an additional identification device, such as an identification that the object 101a-n has been associated with an electronic transaction. In this manner, environment application 115 can determine that actions taken by a user are associated with the transaction, and compare the actions to historical data. For example, if identification device 102b receives an indication that the particular object has been purchased, then environment application 115 stores the information in a profile within the particular environment data structure. In this manner, environment application 115 can provide offers or promotions based on the transaction. For example, if identification device 102a subsequently identifies the user who purchased the particular object in the environment, then environment application 115 can provide an offer via mobile device to the user.

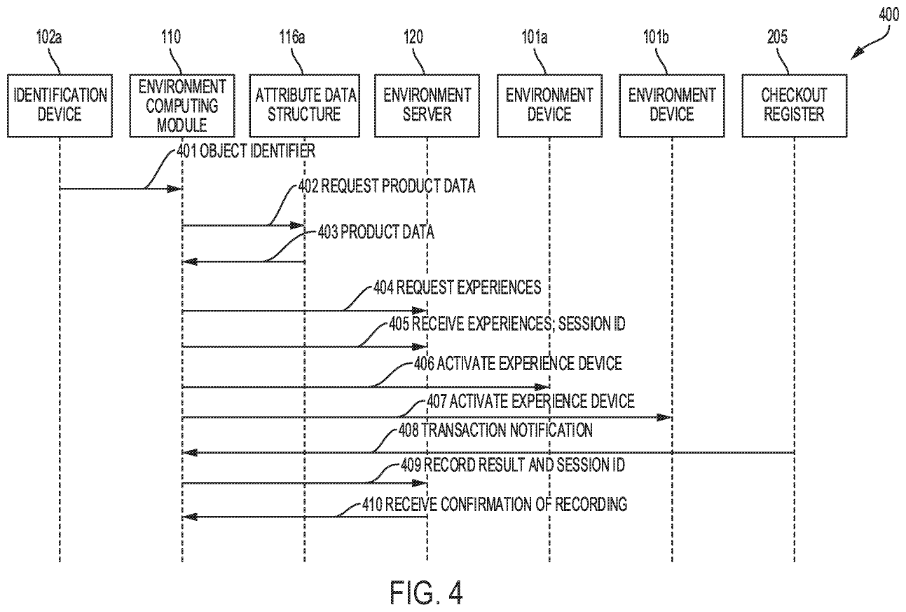

FIG. 4 depicts an example of a data flow for the environment modification system of FIG. 1, according to certain embodiments of the present disclosure. For example, at step 401 of FIG. 4, identification device 102a detects a presence of object 101a and transmits an object identifier to environment computing module 110. In an embodiment, the identifier can be obtained from an RFID tag on object 101a. Identification device 102a receives the identifier in a pulse from the RFID tag and forwards the identifier to the environment application 115. In another embodiment, the identifier is stored in memory.

At step 402, environment application 115 accesses attribute data structure 116a, which includes properties about the object 101a such as a targeted demographic such as gender or age. In some cases, the attribute data structure 116a indicates an attribute, such as an attribute based on historical information about interactions with objects similar to the object 101a. Additionally or alternatively, the attribute data structure 116a identifies at least one characteristic of a user, or group of users, of the physical environment. At step 403, environment application 115 obtains attribute data, such as product data about object 101a, from attribute data structure 116a.

At step 404, environment application 115 requests an environment data structure that corresponds to one or more attributes in attribute data structure 116a. For example, if object 101a is a baseball cap, then attribute data structure 116a includes information such as a particular baseball team and size of the cap. In another example, if object 101a is associated with youth, then attribute data structure 116a may include information such as a targeted age range of 12-18. Environment application 115 requests an environment data structure that includes configuration information for environment devices based on the attributes. In some cases, the configuration information is based on one or more of the historical information, the characteristic, or any combination of these.

At step 405, environment application 115 receives environment data structure 125a from environment server 120. At step 405, environment computing module 110 optionally receives a session identifier. A session identifier is used to identify transactions and events that occur in association with the detected object 101a-n and environment computing module 110. For example, a session identifier can be used to separate a session in which a first user interacts with a first object and another session in which a second user interacts with a second object.

At steps 406-407, environment application 115 activates one or more environment devices 140a-n according to environment data structures 125a. For example, environment data structure 125a specifies that in response to the attribute “baseball,” that environment device 140a should activate lights that correspond with colors for a local baseball team, and environment device 140b should play audio of famous baseball games (e.g., audio recordings of broadcast games). Accordingly, environment application 115 activates environment device 140a and environment device 140b consistent with information provided in environment data structure 125a.

At step 408, environment computing module 110 receives a notification from checkout register 205 that the user has purchased or otherwise transacted with object 101a. In some cases, the notification can include additional information, such as a purchase price, a discounts, or identification of additional objects purchased with the object 101a.

At step 409, environment computing module 110 records the session identifier and the result of the transaction in a data structure such as environment data structures 125a-n on environment server 120. At step 410, environment computing module 110 receives a confirmation from environment server 120 that the transaction has been recorded.

Maintaining environment data structures 125a-n provides environment application 115 the capability to evaluate the effectiveness of various activations of environment devices 140a-n. For example, environment application 115 can implement variations of environment device activations to determine which environment modifications are effective. For example, in response to a particular object, environment application 115 activates a first environment configuration, such as by activating a first set of devices from the environment devices 140a-n. Subsequently, in response to the particular object, environment application 115 activates a second environment configuration, such as by activating a second set of devices, or activating the first device set with modified output levels. Environment application 115 measures the results including the transactions that occurred as a result of the first and second environment configurations. If environment application 115 determines that no appreciable difference occurred in transactions or outcomes between the first and second configurations, then environment application 115 may attempt a third environment configuration if the particular object is subsequently identified.

Environment application 115 can use predictive models such as machine learning models or statistical models to predict whether a particular activation of environment devices 140a-n will be effective for a particular set of objects. For example, environment application 115 can provide an object identifier and an attribute data structure 116a-n to a predictive model. In addition, the environment application 115, receive a prediction of an optimal activation of environment devices 140a-n.

### Example of a Computing System for Implementing Certain Embodiments

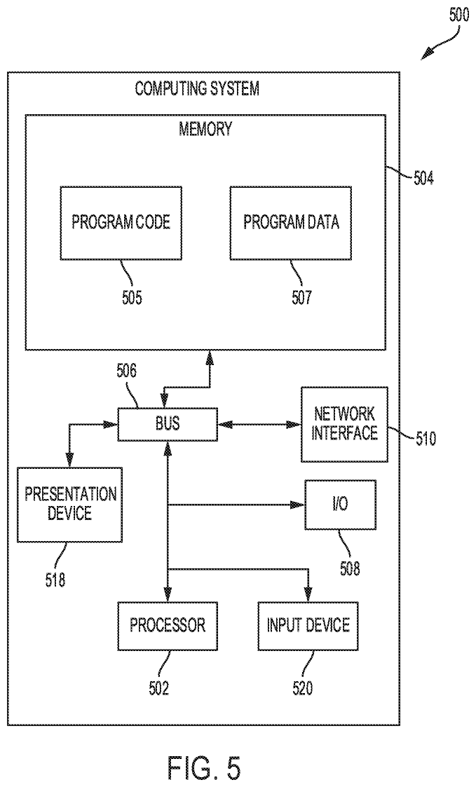

Any suitable computing system or group of computing systems can be used for performing the operations described herein. For example, FIG. 5 depicts an example of a computing system for implementing certain embodiments of the present disclosure. The implementation of computing system 500 could be used for one or more of environment computing module 110 or environment server 120.

The depicted example of a computing system 500 includes a processor 502 communicatively coupled to one or more memory devices 504. The processor 502 executes computer-executable program code stored in a memory device 504, accesses information stored in the memory device 504, or both. Examples of the processor 502 include a microprocessor, an application-specific integrated circuit (“ASIC”), a field-programmable gate array (“FPGA”), or any other suitable processing device. The processor 502 can include any number of processing devices, including a single processing device.

A memory device 504 includes any suitable non-transitory computer-readable medium for storing program code 505, program data 507, or both. Program code 505 and program data 507 can be from environment application 115, attribute data structure 116a, environment data structures 125a-n, or any other applications or data described herein. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 500 may also include a number of external or internal devices, an input device 520, a presentation device 518, or other input or output devices. For example, the environment modification system 100 is shown with one or more input/output (“I/O”) interfaces 508. An I/O interface 508 can receive input from input devices or provide output to output devices. One or more buses 506 are also included in the computing system 500. The bus 506 communicatively couples one or more components of a respective one of the computing system 500.

The computing system 500 executes program code 505 that configures the processor 502 to perform one or more of the operations described herein. Examples of the program code 505 include, in various embodiments, modeling algorithms executed by the environment application 115, or other suitable applications that perform one or more operations described herein. The program code may be resident in the memory device 504 or any suitable computer-readable medium and may be executed by the processor 502 or any other suitable processor.

In some embodiments, one or more memory devices 504 stores program data 507 that includes one or more datasets and models described herein. Examples of these datasets include interaction data, environment metrics, training interaction data or historical interaction data, transition importance data, etc. In some embodiments, one or more of data sets, models, and functions are stored in the same memory device (e.g., one of the memory devices 504). In additional or alternative embodiments, one or more of the programs, data sets, models, and functions described herein are stored in different memory devices 504 accessible via a data network.

In some embodiments, the computing system 500 also includes a network interface device 510. The network interface device 510 includes any device or group of devices suitable for establishing a wired or wireless data connection to one or more data networks. Non-limiting examples of the network interface device 510 include an Ethernet network adapter, a modem, and/or the like. The computing system 500 is able to communicate with one or more other computing devices via a data network using the network interface device 510.

In some embodiments, the computing system 500 also includes the input device 520 and the presentation device 518 depicted in FIG. 5. An input device 520 can include any device or group of devices suitable for receiving visual, auditory, or other suitable input that controls or affects the operations of the processor 502. Non-limiting examples of the input device 520 include a touchscreen, a mouse, a keyboard, a microphone, a separate mobile computing device, etc. A presentation device 518 can include any device or group of devices suitable for providing visual, auditory, or other suitable sensory output. Non-limiting examples of the presentation device 518 include a touchscreen, a monitor, a speaker, a separate mobile computing device, etc.

Although FIG. 5 depicts the input device 520 and the presentation device 518 as being local to the computing device that executes the environment application 115, other implementations are possible. For instance, in some embodiments, one or more of the input device 520 and the presentation device 518 can include a remote client-computing device that communicates with the computing system 500 via the network interface device 510 using one or more data networks described herein.

In some embodiments, a computing system, such as the computing system 500, performs operations including receiving, from an electronic identification device, an identifier of an object in a physical environment. The operations also include determining an attribute based on the object identifier. The attribute identifies, for example, a characteristics of users of the physical environment. The operations also include matching the attribute to a parameter that indicates an environment device (e.g., included in or capable of affecting the physical environment) and a configuration of the environment device. The configuration is based, for example, on the characteristic of the users. The operations further include changing a behavior of the environment device by implementing the configuration.

Additionally or alternatively, a computing system, such as the computing system 500, includes a non-transitory computer-readable medium that embodies program code. The program code includes operations including receiving, from an electronic identification device, an identifier of an object in a physical environment and data about an interaction of a user in the physical environment with the object. The operations also include determining an attribute based on the object identifier. The operations also include identifying, based on the attribute, additional objects that are similar to the object, and a characteristic of a group of users that have interacted with the additional objects. The operations further include determining that the user has the characteristic of the group of users, based on the interactions of the user with the object in the physical environment.

Additionally or alternatively, an environment modification system, such as an environment modification system that includes the computing system 500, includes one or more means for performing operations or steps. The means include, for example, determining an attribute for an identifier of an object in a physical environment, based on previous interactions in the physical environment. The means also include identifying an environment data structure that describes a configuration profile with a parameter of an environment device (e.g., included in or capable of affecting the physical environment). The means include matching the parameter to the determined attribute, such that the parameter indicates a configuration (e.g., of the environment device) that is based on the previous interactions in the physical environment. The means further include changing a behavior of the environment device by implementing the configuration.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes poses of example rather than limitation, and does not preclude the inclusion of such modifications, variations, and/or additions to the present subject matter as would be readily apparent to one of ordinary skill in the art.

1. A method for configuring a physical environment based on detected interactions with the physical environment, wherein the method includes one or more processing devices performing operations comprising:
receiving, from an electronic identification device, a notification indicating a presence of an object in the environment and an identifier corresponding to the object;
determining, from an attribute data structure, at least one attribute that corresponds to the identifier and that identifies at least one characteristic of a group of users of the physical environment;
matching the attribute to a parameter in an environment data structure obtained from an environment server, wherein the parameter indicates (i) an environment device, and (ii) a configuration of the environment device, wherein the configuration is based on the identified characteristic of the group of users; and
changing a behavior of the environment device by implementing the configuration on the environment device.

2. The method of claim 1, the operations further comprising:
detecting, by an additional identification device, that the object has been associated with an electronic transaction; and
storing, in the environment data structure, a profile that associates the object and the transaction with a user.

3. The method of claim 2, the operations further comprising:
receiving, from the electronic identification device, an additional notification indicating a presence of the user in the environment;
accessing the profile from the environment data structure; and
activating an additional environment device according to the profile.

4. The method of claim 2, the operations further comprising:
modifying the parameter based on the indication that the object is associated with the electronic transaction; and
providing the modified parameter to the environment server.

5. The method of claim 1, wherein the environment device is selected from one or more of (i) a light, (ii) a sound-emitting device, or (iii) a fragrance-emitting device.

6. The method of claim 1, wherein the electronic identification device is a radio frequency identification device (RFID) and the object comprises an RFID tag.

7. The method of claim 1, wherein changing the behavior of the environment device comprises providing a command indicating a function of the environment device and an output level of the function, wherein the environment device is capable of modifying the indicated function to produce output at the indicated output level.

8. A non-transitory computer-readable medium embodying program code for configuring a physical environment based on detected interactions with the physical environment, the program code comprising instructions which, when executed by a processor, cause the processor to perform operations comprising:
receiving, from an electronic identification device, i) sensor data indicating an interaction of a user with an object in the environment and (ii) an identifier corresponding to the object;
determining, from an attribute data structure, an attribute that corresponds to the object identifier;
based on the attribute, identifying (i) additional objects similar to the object in the environment, (ii) at least one characteristic of a group of users of the physical environment, and (iii) previous interactions of the group of users with the additional objects; and
based on the attribute and the interaction of the user with the object, determining that the user has the at least one characteristic of the group of users.

9. The non-transitory computer-readable medium of claim 8, the operations further comprising:
determining a configuration profile for an environment device based on the at least one characteristic of the group of users, wherein the configuration profile describes a configuration of the environment device based on the previous interactions of the group of users with the additional objects;
matching the attribute to a parameter indicating the configuration profile of the environment device; and
changing a behavior of the environment device by implementing the configuration profile on the environment device.

10. The non-transitory computer-readable medium of claim 9, wherein changing the behavior of the environment device comprises providing a command indicating a function of the environment device and an output level of the function, wherein the environment device is capable of modifying the indicated function to produce output at the indicated output level.

11. The non-transitory computer-readable medium of claim 8, the operations further comprising:
detecting, by an additional identification device, that the object has been associated with an electronic transaction; and
storing, in the environment data structure, a user profile that associates the object and the transaction with the user.

12. The non-transitory computer-readable medium of claim 11, the operations further comprising:
receiving, from the electronic identification device, additional sensor data indicating a presence of the user in the environment;
accessing the user profile from the environment data structure; and
activating an environment device according to the user profile.

13. The non-transitory computer-readable medium of claim 11, the operations further comprising:
determining a parameter based on the indication that the object is associated with the electronic transaction; and
providing the parameter to the environment server.

14. An environment modification system comprising:
a means for determining, from an attribute data structure, at least one attribute that corresponds to an identifier of an object in a physical environment, wherein the attribute is determined based on previous interactions in the physical environment;
a means for identifying, based on the attribute, an environment data structure that includes information describing the previous interactions and a configuration profile for an environment device, wherein the configuration profile includes a parameter associated with the environment device;
a means for matching the attribute to the parameter, wherein the parameter indicates a configuration of the environment device, wherein the configuration is based on the previous interactions; and
a means for changing a behavior of the environment device by implementing the configuration on the environment device.

15. The environment modification system of claim 14, further comprising:
a means for detecting that the object has been associated with an electronic transaction; and
a means for storing, in the environment data structure, a user profile that associates the object and the transaction with a user.

16. The environment modification system of claim 15, further comprising:
a means for receiving, from an electronic identification device, an indication of a presence of the user in the environment;
a means for accessing the user profile from the environment data structure; and
a means for activating an additional environment device according to the user profile.

17. The environment modification system of claim 15, further comprising:
a means for modifying the parameter based on the indication that the object is associated with the electronic transaction; and
a means for providing the modified parameter to the environment server.

18. The environment modification system of claim 14, wherein the environment device is selected from one or more of (i) a light, (ii) a sound-emitting device, or (iii) a fragrance-emitting device.

19. The environment modification system of claim 14, further comprising an electronic identification device, wherein the electronic identification device is a radio frequency identification device (RFID) and the object comprises an RFID tag.

20. The environment modification system of claim 14, wherein changing the behavior of the environment device comprises providing a command indicating a function of the environment device and an output level of the function, wherein the environment device is capable of modifying the indicated function to produce output at the indicated output level.
